(19) United States
(12) Patent Application Publication
(10) Pub. No.: US 2003/0045420 A1
(43) Pub. Date: Mar. 6, 2003

(54) Mother glass for laser processing and glass for laser processing

(75) Inventors: Tadashi Koyama, Osaka-shi (JP); Tetsuro Yoshii, Osaka-shi (JP); Hirotaka Koyo, Osaka-shi (JP)

Correspondence Address: SUGHRUE MION, PLLC, 2100 PENNSYLVANIA AVENUE, N.W., WASHINGTON, DC, 20037, US

(73) Assignee: NIPPON SHEET GLASS CO., LTD.

(21) Appl. No.: 10/086,414

(22) Filed: Mar. 4, 2002

(30) Foreign Application Priority Data
Mar. 5, 2001 (JP) P. 2001-060680

(51) Int. Cl. C04B 35/00

(52) U.S. Cl. 501/1

(57) ABSTRACT

A mother glass for producing a glass adapted for laser processing utilizing abrasion or evaporation by absorbed laser energy, includes: a silicate glass as a main component; and aluminum and at least one alkali metal in substantially the same molar amount.

### BACKGROUND OF THE INVENTION

1. Field of the Invention

The present invention relates to laser processing of glass by irradiating glass with a laser light and, more particularly, to a glass composition suitable for laser processing.

2. Description of the Related Art

A silicate glass is transparent and can be easily molded or deformed at a high temperature, and have found various uses including window glass. It is cut, abraded and deformed to commercialize for each particular use. In many uses, it is required to subject the glass to fine processing and, as the processing method, there are known a chemical etching method using an etching solution and a physical etching by, for example, ion irradiation. In addition, as a physicochemical means, there is a reactive ion etching method which has been utilized for manufacturing optical parts such as a micro-lens array and a diffraction grating. In this method, a fine mask pattern of an organic material is formed on the glass according to the lithographic technology, and the glass at the unmasked areas is removed by ion activated by plasma or the like to form a fine structure on the glass. This method, however, involves the problem that a number of complicated steps are required, and that a highly vacuum vessel is required as an etching apparatus, leading to a high production cost.

On the other hand, with the development of laser technology, laser processing has vigorously been studied. In the laser processing, lasers having various wavelengths are being used. For example, there are illustrated an infrared laser such as CO₂ laser; a laser with a wide region of wavelength ranging from near infrared to visible light or UV ray region, emitted by combining an Nd:YAG laser and a wavelength converter; and an UV laser such as excimer laser. The laser processing is a technology in which these lasers are irradiated to a material to cause physical change such as heating, melting, evaporation or abrasion, with the physical change being utilized for the processing of the material. The laser beam (laser light) can be focused through a lens to a size of micrometer to submicrometer order, and can be scanned easily using a reflector. Such laser processing has the advantages that it does not require the vacuum vessel and permits to conduct it in the atmosphere, and that it does not require the lithography step since a pattern can directly be drawn by scanning the laser beam, thus finding wider applications. Materials to be subjected to the laser processing include various materials such as organic materials, metals and ceramics.

As is described above, the laser processing permits micrometer-order processing by properly focusing the laser beam and is expected as a means for conducting fine processing in a short time at a low cost. If an uneven pattern can be formed on the surface of a glass, particularly a silicate glass, or fine pores can be formed by the laser processing, the laser processing can find wide applications to parts for optical communication, substrates for mounting elements for optical communication, display glasses, etc.

However, application of the fine processing by the laser to a silicate glass having wide uses has scarcely advanced. This can be attributed to the fact that glasses are typical fragile materials and cannot resist against the impact upon processing, thus being liable to form cracks and chips. In addition, the processing marks cannot be finished to be smooth, so that the processed surface is often rough, and thus it has been difficult to employ the laser processing for use in fine processing. Such disadvantages are described in detail in Glastech. Ber., vol.66 (1993), p.227 and Applied Surface Science, vol.86 (1995), p.223.

What has recently been tried comparatively frequently is to form fine a pore(s) in a glass. As a means to prevent formation of cracks or chips, it has been known to conduct the processing while heating for mitigating stress. Also, it has been tried to form a thin film of a metal such as aluminum around the pore to be processed to thereby mitigate stress. However, in the processing under heating, accuracy of the order of micrometer to submicrometer cannot be attained due to thermal shrinkage and, in addition, the processing requires complicated procedures, thus its use being confined. On the other hand, the processing of using a metal thin film involves the problem that a vacuum process is required for forming the thin film, which spoils the essential superiority of the laser processing that it permits to conduct processing in a short time and in a simple manner, and that it spoils transparency and electrically insulating properties which are characteristic of the glass. Therefore, it has extremely been difficult to conduct laser processing of a glass simply with a good accuracy.

The inventors have formerly disclosed, as shown in Japanese Patent Laid-Open No 217237/1999, the technology of providing a glass which has a reduced threshhold value of laser processing and which difficultly forms cracks, by introducing silver into the glass through ion-exchanging. Threshhold values of various alkali metal-containing glasses can be decreased by this technique.

However, although silver ion can be introduced into many of the alkali metal-containing glasses by the silver ion-exchanging technique, there arises the phenomenon that the silver ion is reduced in the vicinity of the glass surface and, as a result, is prevented from diffusing into the inside of the glass. Therefore, effective laser processing regions are limited to the vicinity of the glass surface, and it is still difficult to conduct processing to the inside of the glass such as processing of penetrating a hole(s) (forming a throughhole(s)) in a glass plate. In addition, there is the problem that the ion-exchanging rate is so slow that it is difficult to allow the ion to stably reach the inside of the glass.

### SUMMARY OF THE INVENTION

In order to solve the above-described problems, an object of the present invention is to provide a mother glass adapted for laser processing, in which silver ion easily diffuses and which enables to incorporate the silver component in a high concentration by ion-exchanging.

The mother glass of the invention adapted for laser processing contains a silicate glass as a main component and aluminum and at least one alkali metal in substantially the same (molar) amount.

The mother glass preferably contains silicon dioxide (SiO₂) in an amount of 30 to 65 mol %, more preferably 35 to 65 mol %.

The mother glass preferably contains each of the aluminum and the at least one alkali metal in an amount of 1 to 30 mol %, more preferably 10 to 30 mol %.

The examples of the alkali metal include sodium and potassium.

Particularly, in the case where sodium is used as the alkali metal, aluminum and sodium are preferably within the following composition ranges (unit: mol %):

1.0≧Al₂O₃≧30.0

1.0≧Na₂O≧30.0

with the composition ratio of Al₂O₃/Na₂O being in the range of:

0.9≧Al₂O₃/Na₂O≧1.1.

The mother glass preferably comprises: 30 to 65 mol % of SiO₂; 1 to 30 mol % of Al₂O₃; 1 to 30 mol % of Na₂O; 5 to 20 mol % of B₂O₃; 0 to 20 mol % of MgO; and 0 to 20 mol % of ZnO.

All or part of Na⁺ ion in the glass is replaced with Ag⁺ ion by the ion-exchanging method using a silver-containing molten salt according to the ion-exchanging method. The thus silver-incorporated glass is allowed to absorb laser energy through the mono-photon absorbing process or the multi-photon absorbing process to thereby cause abrasion or evaporation. A specific portion of the glass can be removed by utilizing this phenomenon. The glass of the invention adapted for laser processing can be processed using a laser source emitting laser beams ranging from 200 to 800 nm in wavelength.

In the invention, concentration of aluminum is adjusted to be the same as that of Na⁺ ion in the glass to thereby improve the ion-exchanging rate and facilitate ion-exchanging. In addition, since precipitation of silver colloid is difficult to take place during ion-exchanging, the silver ion can fully diffuse into the inside of the glass. These actions result from the fact that the amount of non-crosslinked oxygen is decreased by the introduction of Al₂O₃ into the silicate glass and that the concentration is minimized by mixing aluminum with the alkali in the same concentration (see, for example, Journal of Non-Crystalline Solids, vol.113 (1989), p.37). By using such glass, there is obtained a glass with a low processing threshhold value which does not form cracks upon laser processing, which enables continuous processing of forming pores, and which requires a less energy for the laser processing.

### BRIEF DESCRIPTION OF THE DRAWING

FIG. 1 is a schematic view showing the optical system for measuring threshhold value for laser processing.

The reference numerals used in the drawing are set forth below.

10 Laser beam

12 Laser source

20 Glass sample

22 Sample holder

24 Sample stage

30 Irradiation shutter

40 Power meter

### DETAILED DESCRIPTION OF THE INVENTION

An object of the invention is to improve laser processability of a glass, and its substance lies in that laser processing with a less energy can be conducted from the glass surface to the inside thereof. As an indication for evaluating such laser processability, processing threshhold values on the surface and in the inside of the glass are employed.

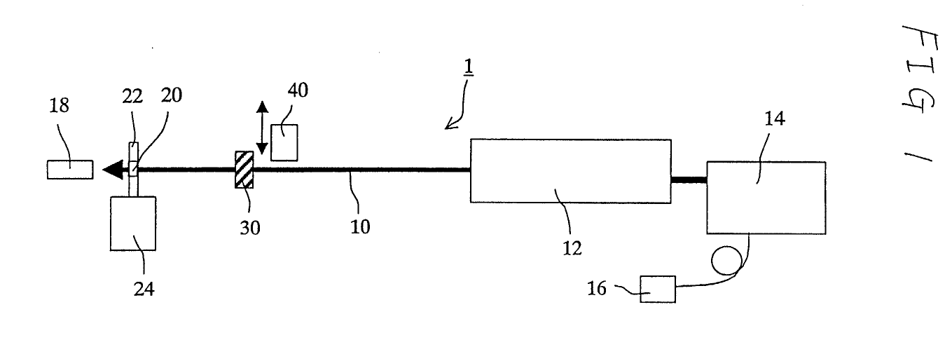

The processing threshhold value was measured using the optical system 1 shown in FIG. 1. As a laser source 12, an Nd:YAG laser of 266 nm and 355 nm in UV wavelength was used. Repeating frequency and pulse width of this laser were adjusted to 20 Hz and 5 to 8 nm, respectively. Laser beam 10 was focused with a lens (not shown) of 100 mm in focal length, and was directed to a glass sample 20 fixed by the sample holder 22 on the sample stage 24 to irradiate. Irradiation time was controlled to be 2 seconds by means of the irradiation shutter 30.

Energy of the laser beam 10 was measured by placing a power meter 40 on the ray path of the laser beam 10 with the irradiation shutter 30 closed. The sample 20 was irradiated with changing the energy to determine the critical energy at which abrasion took place, the critical energy measured in terms of power being taken as the processing threshhold value.

Additionally, since the laser source 12 generates a high energy beam, it is designed to be operable by remote control, and the power source/cooling water supplier 14 for the laser source 12 is operated by the controller 16. Though not shown, the laser source 12 itself has a shutter which can be operated by remote control. The laser beam passed through the sample 20 is absorbed by a beam damper 18.

The term “mother glass adapted for laser processing” as used herein means a glass before being ion-exchanged, and the term “glass adapted for laser processing” as used herein means a glass after being ion-exchanged. The mother glasses were prepared by mixing predetermined starting materials, melting the mixture in an electric furnace, and gradually cooling the molten mixture. The resultant transparent glass blocks were cut and abraded in a common manner to prepare plate-like mother glass samples for experiments having a smooth surface.

### EXAMPLES 1 TO 6

Composition of the mother glasses for processing used as samples are shown in Table 1. The main component was SiO₂, and sodium was used as the alkali metal Contents of the respective components fall within the following ranges in terms of mol %:

SiO₂: 37.5 to 58.0

Al₂O₃: 5.0 to 25.0

Na₂O: 5.0 to 25.0

B₂O₃: 8.0 to 15.0

MgO: 0 to 15.0

ZnO: 0 to 10.0

Additionally, contents of Al₂O₃ and Na₂O were adjusted to be the same.

Mother glasses having the above-described composition were prepared in the above-described manner, and were shaped into 0.3-mm thick plates to be used as mother glass samples. A 50 mol %-50 mol % mixture of silver nitrate and sodium nitrate was heated to 400° C. in a stainless steel-made reaction vessel to prepare the molten salt for conducting ion-exchanging. The above-described mixed salts became liquid at this temperature, and the ion-exchanging was conducted by dipping the mother glass samples in the liquid molted salt mixture. The time required for the ion exchanging varies depending upon the samples because ion-exchanging rate varies depending upon the contents of the materials constituting the samples. Therefore, the shortest time (for the sample containing 25 mol % of Na) was 2 days, and the longest time (for the sample containing 5 mol % of Na) was 35 days. By this ion-exchanging treatment, Na⁺ ion located at the surface of the glass dissolves out, and Ag+ ion contained in the salt diffuses into the glass (thus so-called ion exchange generating). Analysis of the thickness of layer, through which silver diffused, by means of an X-ray microanalyzer revealed that Na was completely replaced by silver over the full thickness of 0.3 mm.

These glass samples adapted for laser processing were irradiated with laser beam of 266 nm in wavelength with changing irradiation energy. For the purpose of comparison, the mother glasses not having been ion-exchanged were also irradiated. Surface processing threshhold values thus obtained are tabulated in the upper section in Table 2. With the non-ion-exchanged mother glasses, all samples did not cause abrasion even when irradiated with a maximum power of the used laser of 400 mW. Further, when the ion-exchanged glass samples were abraded to the depth of 150 μm and subjected to the same experiments for determining the processing threshhold values, about the same processing threshhold values as that of the surface were obtained as shown in the lower section of Table 2.

Additionally, in the above-described glass samples, yellow to brown coloration to be observed when precipitation of silver colloid occurred after the ion exchanging treatment was not observed. Therefore, it is considered that precipitation of colloid did not generate. It is seen that this is the factor that a good laser processability is realized to the inside of the glass.

Then, the same experiments were conducted except for changing the wavelength of the laser to 355 nm. The resultant processing threshhold values are shown in the upper section of Table 3. A sample containing 5 mol % of Al contained only 5% of silver, and hence it had such a high processing threshhold value that it could not be abraded even at the maximum power of used laser, thus effective measurement being impossible. With the non-ion-exchanged mother glasses, all samples did not cause abrasion even when irradiated with the limit power of the used laser of 1.8 W. Further, when the ion-exchanged glass samples were abraded to the depth of 150 μm and subjected to the same experiments for determining the processing threshhold values, about the same processing threshhold values as that of the surface were obtained as shown in the lower section of Table 3.

### Comparative Example 1

As a comparative example, the material shown in Table 4 was used. This was so-called soda-lime glass used for common window glasses. This glass was abraded to the thickness of 0.3 mm, and was subjected to ion-exchanging treatment for 30 days under the same conditions as in Example 1. Observation of the ion-exchanged glass revealed that the glass was colored brown. A strong absorption was observed at around 450 nm by the measurement of absorption spectrum of this glass, which showed that silver colloid was precipitated. Observation of the glass at the vicinity of the glass surface with an electron microscope revealed that silver colloid having a diameter of about 30 nm was precipitated. When the processing threshhold value was determined in the same manner as in Example, the glass showed a value of 53 mW at 266 nm and 800 mW at 355 nm, thus showing a comparatively good processing threshhold value.

However, with a sample having been abraded to 150 um, the abraded surface did not cause abrasion, though the back side (non-abraded surface) caused abrasion. This showed that ion exchanging did not reach the inside of the glass. This may be attributed to that, since ion-exchanged silver became colloidal at the surface layer, a kind of barrier was formed at the surface which prevented mutual diffusion of the ions to the inside of the glass. Generation of such colloid strongly depends upon presence or absence of non-crosslinked oxygen, and the major factor thereof is considered to be deviation of the ratio of aluminum to sodium which controls the presence.

### Comparative Example 2

A glass was prepared by mixing the raw materials according to the composition shown in Table 5. The glass was subjected to the ion-exchanging treatment, and the laser processing threshhold value was determined to be as good as 20 mW or less at266 nm. Water resistance of this glass was measured according to the dust-method water resistance test provided by Nihon Garasu Kogyokai (Japan Glass Industry Association), and a weight loss of 1% by weight or more was found. This corresponds to grade 6 according to the standard for water resistance, which is a level impossible to be put into practice. The deterioration in water resistance results from mixing Na in a large quantity. In the practical point of view, the limit as to Na content is considered to be about 30 mol %.

It is seen from the above Examples and Comparative Examples that mother glasses adapted for laser processing and containing a silicate glass as a main component preferably contains aluminum and sodium in the following composition (unit: mol %) for the purpose of conducting uniform exchange with silver ion to the inside thereof:

1.0≧Al₂O₃≧30.0

1.0≧Na₂O≧30.0

In addition, contents of aluminum and sodium are desirably the same. However, in actual mixing of the materials, there arises fluctuation of about ±10% in composition ratio. Such fluctuation does not exert detrimental influences on the threshhold value of laser processing, and hence preferred composition ratio of aluminum to sodium in the invention is in the range of:

0.9≧Al₂O₃/Na₂O≧1.0

Additionally, the alkali metal is not limited to the above-described sodium, but may be any element that can be ion-exchanged with silver. Thus, potassium or the like is also usable. Other additives are not limited to the elements and the contents described in the Examples, either, and may properly be selected in consideration of the melting point, optical properties and weather ability of the glass.

The mechanism how the laser processability is improved by the presence of silver lies in generation of silver colloid caused by irradiation with laser. It is considered that generation of silver colloid in the glass serves to cause a strong absorption of laser beam within the glass, thus the laser beam energy being effectively utilized to realize smooth processing.

Therefore, although the effects are demonstrated with respect to the specific wavelength (third and fourth harmonic component) of Nd:YAG laser, laser beam of 200 to 800 nm in wavelength can cause generation of silver colloid and a strong absorption thereof, thus processability being improved similarly. As practical high output laser beams, there may be used KrF excimer laser (wavelength=248 nm), a second harmonic component of Nd:YAG laser (wavelength=532 nm), a fifth harmonic component (wavelength=212 nm), Nd:YVO₄ laser (wavelength the same as Nd:YAG), a harmonic component of YLF laser (wavelength=523 nm, 349 nm, 262 nm) or Ti:Al₂O₃laser (wavelength =around 800 nm but, in biphoton absorption, around 400 nm)

TABLE 1
(unit: mol %)

| Component | Ex. 1 | Ex. 2 | Ex. 3 | Ex. 4 | Ex. 5 | Ex. 6 |
|---|---|---|---|---|---|---|
| SiO₂ | 58.0 | 58.0 | 56.0 | 56.0 | 40.0 | 37.5 |
| Al₂O₃ | 5.0 | 8.0 | 11.0 | 15.0 | 25.0 | 25.0 |
| Na₂O | 5.0 | 8.0 | 11.0 | 15.0 | 25.0 | 25.0 |
| B₂O₃ | 15.0 | 15.0 | 10.0 | 8.0 | 10.0 | 12.5 |
| MgO | 15.0 | 1.0 | 6.0 | 3.0 | 0.0 | 0.0 |
| ZnO | 2.0 | 10.0 | 6.0 | 3.0 | 0.0 | 0.0 |
| Total | 100.0 | 100.0 | 100.0 | 100.0 | 100.0 | 100.0 |

TABLE 2

| | Ex. 1 | Ex. 2 | Ex. 3 | Ex. 4 | Ex. 5 | Ex. 6 |
|---|---|---|---|---|---|---|
| Threshhold value | 195 | 112 | 98 | 51 | 32 | 33 |
| for surface | | | | | | |
| processing (mW) | | | | | | |
| Threshhold value | 198 | 111 | 95 | 48 | 28 | 30 |
| for inside | | | | | | |
| processing (mW) | | | | | | |

TABLE 2

| | Ex. 1 | Ex. 2 | Ex. 3 | Ex. 4 | Ex. 5 | Ex. 6 |
|---|---|---|---|---|---|---|
| Threshhold value | *1 | 1620 | 1080 | 860 | 430 | 420 |
| for surface | | | | | | |
| processing (mW) | | | | | | |
| Threshhold value | *1 | 1610 | 1070 | 870 | 420 | 420 |
| for inside | | | | | | |
| processing (mW) | | | | | | |

*1: impossible to be processed

TABLE 4

| | (unit: mol %) |
|---|---|
| Component | Comparative Example 1 |
| SiO₂ | 72.0 |
| Al₂O₃ | 0.9 |
| Na₂O | 12.7 |
| MgO | 6.0 |
| CaO | 8.4 |

TABLE 5

| | (unit: mol %) |
|---|---|
| Component | Comparative Example 1 |
| SiO₂ | 19.5 |
| Al₂O₃ | 35.0 |
| Na₂O | 35.0 |
| B₂O₃ | 10.5 |
| MgO | 0.0 |
| ZnO | 0.0 |
| Total | 100.0 |

The present invention provides a glass which does not suffer formation of cracks or chips upon processing with laser, of which irradiated surface is smooth, and which ensures a removal of an amount in proportion to the irradiation energy. Further, since the glass enables to introduce silver ion to the inside thereof without formation of colloids, the glass is adapted for processing to form holes or deep grooves which require processing to the inside from the surface thereof.

This application is based on Japanese patent application JP 2001-60680, filed Mar. 5, 2001, the entire content of which is hereby incorporated by reference, the same as if set forth at length.

What is claimed is:

1. Another glass for producing a glass adapted for laser processing utilizing abrasion or evaporation by absorbed laser energy, which comprises: silicon dioxide as a main component; and aluminum and at least one alkali metal in substantially the same molar amount.

2. The mother glass according to claim 1, which is a SiO₂-containing glass, wherein the contents of Al₂O₃ and Na₂O as the aluminum and the alkali metal are within the following ranges in terms of mol %:
1.0≧Al₂O₃≧30.0
1.0≧Na₂O≧30.0, and
the molar ratio of Al₂O₃/Na₂O is in the range of:
0.9≧Al₂O₃/Na₂O≧1.1.

3. The mother glass according to claim 2, which comprises:
30 to 65 mol % of SiO₂; 1 to 30 mol % of Al₂O₃; 1 to 30 mol % of Na₂O; 5 to 20 mol % of B₂O₃; 0 to 20 mol % of MgO; and 0 to 20 mol % of ZnO.

4. A glass adapted for laser processing, which is produced by replacing all or part of the alkali metal in the mother glass according to claim 1, with silver by an ion-exchanging method.

5. The glass adapted for laser processing according to claim 4, which is capable of being subjected to processing with a laser light having a wavelength range of 200 nm to 800 nm.
